(19) United States
(12) Patent Application Publication
(10) Pub. No.: US 2025/0372362 A1
(43) Pub. Date: Dec. 4, 2025

(54) METHOD FOR DETERMINING ABUNDANCE OF IONS

(71) Applicant: Thermo Fisher Scientific (Bremen) GmbH, Bremen (DE)

(72) Inventors: Dmitry Grinfeld, Bremen (DE); Konstantin Ayzikov, Bremen (DE); Dmitry Strelnikov, Heidelberg (DE); Nils Kuhlbusch, Bremen (DE)

(73) Assignee: Thermo Fisher Scientific (Bremen) GmbH, Bremen (DE)

(21) Appl. No.: 19/220,491

(22) Filed: May 28, 2025

(30) Foreign Application Priority Data
May 29, 2024 (GB) 2407587.1

(51) Int. Cl. H01J 49/42

(52) U.S. Cl. CPC H01J 49/425

(57) ABSTRACT

A method for determining an initial abundance of one or more of a plurality of ions in an ion sample is provided. The ion sample is analysed by a Fourier Transform Mass Spectrometer with the plurality of ions decaying over time during the analysis. The method comprises obtaining a mass spectrum of the ion sample. The mass spectrum includes a plurality of peaks indicating the abundance of each of the plurality of ions in the ion sample over an analysis time duration. The method further comprises calculating the initial amplitude of a transient signal of a first ion of the plurality of ions using a fit of an inverse Fourier Transform, FT, of a first peak of the plurality of peaks.

### CROSS REFERENCE TO RELATED APPLICATION

This application claims priority from GB 2407587.1, filed May 29, 2024, which is incorporated herein by reference.

### FIELD OF THE INVENTION

The present disclosure relates to the field of Fourier Transform mass spectrometry. In particular, the present disclosure relates to a method for improving accuracy of the calculation of ion abundance in an ion sample.

### BACKGROUND

Historically, accurate isotope ratio measurements have been conducted by ionizing a low molecular gas produced by combustion of the analyte, followed by a mass spectrometric analysis. Owing to its great stability, simplicity, dynamic range and ion counts per second the magnetic sector is the preferred platform. Accuracy and precision of isotope ratio measurements are additionally improved by the use of one or multiple reference compounds for calibration. However, the magnetic sector mass spectrometer has a very limited mass resolution narrowing the mass range to small gas molecules like H₂, CH₄, CO₂, O₂, N₂ and SO₂. Sector field mass spectrometer-based isotope analysis of more complex molecules requires their prior conversion/combustion to smaller analysable compounds resulting in bulk isotope information. Compound specific isotope analysis (CSIA) additionally requires compound separation (e.g. by liquid or gas chromatography).

Both Ion Cyclotron Resonance (ICR) and orbital trapping systems (e.g. Orbitrap (RTM)) belong to the class of Fourier Transform Mass Spectrometry (FTMS). Both ICR and orbital trapping systems can offer the required mass accuracy and resolution to resolve the intact molecular analyte ions bearing different heavy isotope substitutions. Different molecules only differing in their isotopic composition or intramolecular position of isotopes may be referred to as isotopocules. In the beam type instruments the ions directly hit the detector and the resulting electron current (reported as the intensity) is direct measure of their count. In Fourier Transform Mass Spectrometry (FTMS) on the other hand, the signal may be induced on the detection by the oscillating ions trapped by electric (orbital trapping) or a combination of electric and magnetic fields (FT ICRMS), digitized, and stored as a transient. Its frequency spectrum is calculated by Fourier transform (with some additional post-processing) and converted to m/z domain via calibration.

Different space-charge effects as well as idiosyncrasies of ion motion adversely affect the coherence of an oscillating ion packet, which leads to distortions in the observed peak intensities. This distortion increases non-linearly with decreasing abundance of an ion population (decreasing signal-to-noise ratio) causing distorted peak amplitude especially for low abundance ion signals. Similarly, the scattering of ions on the background gas molecules result in the observed loss of resolution as well as the distortions to the original peak. Both of these decay mechanisms corrupt the fidelity of the reported signal intensities for the ions. This can lead to inaccuracies and low precisions in any quantitative FTMS analysis especially for low abundance ions and for long transient length (high resolutions). Ultimately, the absolute quantification of compounds in mixtures as well as any ratio of two peaks including isotope ratio analysis as well as targeted quantification with internal standard can be adulterated by this.

A known method (Hilkert, A.; Böhlke, J. K.; Mroczkowski, S. J.; Fort, K. L.; Aizikov, K.; Wang, X. T.; Kopf, S. H.; Neubauer, C. Exploring the Potential of Electrospray-Orbitrap for Stable Isotope Analysis Using Nitrate as a Model. Anal. Chem. 2021, 93 (26), 9139-9148) accounts for the signal intensity instabilities by introducing a compound with a known isotope profile into the FTMS analyser during the experiment to act as a reference. However, reference materials are not available for every compound and this approach significantly complicates the experimental setup resulting in substantial additional costs and significantly increases the required analysis time, adversely affecting the throughput.

### SUMMARY

Against this background and in accordance with a first aspect, there is provided a method for determining an initial abundance of one or more of a plurality of ions in an ion sample being analysed by a Fourier Transform Mass Spectrometer. Specifically, the present disclosure calculates the initial amplitude of a decaying transient signal of an ion isotope using a fit of an inverse Fourier Transform (FT) of a peak of an ion within the mass spectrum. The initial amplitude of the decaying transient signal, i.e. the amplitude before the signal decayed, is determined by extrapolating the abundance of the ion to a time at the start of the analysis.

In particular, in a first aspect a method is provided for determining an initial abundance of one or more of a plurality of ions in an ion sample being analysed by a Fourier Transform Mass Spectrometer, the plurality of ions decaying over time during the analysis, the method comprising:
obtaining a mass spectrum of the ion sample, wherein the mass spectrum includes a plurality of peaks indicating the abundance of each of the plurality of ions over an analysis time duration, T, in the ion sample; and
calculating the initial amplitude of a transient signal of a first ion of the plurality of ions using a fit of an inverse Fourier Transform, FT, of a first peak of the plurality of peaks, wherein the first peak corresponds with the first ion, to extrapolate the abundance of the first ion to a time at the start of the analysis time duration.

The present disclosure recognises that the transient decay in FT MS may be defined by two factors. First, the number of oscillating ions may decrease due to collisions of the ions with the background gas molecules (here referred to as collisional decay). Second, the ions with same m/z may oscillate with different frequencies if trapped in a non-ideally isochronous ion trap. This may result in the phase difference between the ions increasing over time (here referred to as dephasing). Therefore, the partial contributions to the signal peaks sum up to a smaller amplitude than in the beginning of the transient, when all phases were aligned. This first aspect provides the advantage of improving accuracy, precision, repeatability and general quality of a measurement of one or a plurality of ions such as isotopes, isotopologues or isotopocule ratios.

Additionally, or alternatively, calculating the initial amplitude of a transient signal of a first ion may comprise using collisional and dephasing decay parameters of a first peak of the plurality of peaks that corresponds with the first ion, and thereby extrapolating the abundance of the first ion indicated by the mass spectrum to a time at the start of the analysis time duration. This provides the advantage that the initial amplitude can be accurately determined using the collisional decay parameter and the dephasing decay parameter. By using both the collisional decay parameter and the dephasing decay parameter, the initial amplitude can be calculated for ions having high and low abundances. Furthermore, as the decay is separated into both collisional decay and dephasing decay, the collisional decay can be used to determine the collisional cross-section (CCS) of the ions.

Optionally, the method may further comprise determining a collisional decay parameter and/or a dephasing decay parameter of the first peak.

Optionally, determining the collisional and/or the dephasing decay parameter of the first peak comprises: centering the first peak around zero frequency; applying the inverse FT; and fitting a function to the magnitude of the inverse FT. Optionally, the method may comprise fitting a function to the logarithm, or natural logarithm of the inverse Fourier Transform. Optionally, the function may be a linear regression.

Optionally, the determination of the collisional and/or the dephasing decay parameter may comprise fitting the polynomial −αt²−βt−c to the logarithm of the magnitude of the inverse FT. Further optionally, the initial amplitude of the transient signal, I₀, may be calculated from parameter c, wherein I₀=I(0)=e^{c}. Therefore, the initial intensity of the transient signal may be directly calculated from fitting the inverse Fourier Transform to calculate parameter c. Therefore, in some examples, the dephasing and collisional decay rates do not need to be calculated.

Optionally, calculating the initial amplitude of the transient signal may further comprise calculating a correction factor for the abundance, wherein the correction factor is calculated using a collisional decay parameter and a dephasing decay parameter.

Optionally, the correction factor is calculated using the following equation:

$$correction Factor = \frac{1}{2 T} \sqrt{\frac{π}{a}} {e}^{\frac{{β}^{2}}{4 α}} ( erf ( \frac{β + 2 T a}{2 \sqrt{α}} ) - erf ( \frac{β}{2 \sqrt{α}} ) )$$

wherein α is the dephasing decay parameter, and β is the collisional decay parameter.

Optionally, the dephasing decay parameter may be pre-calibrated. For example, the dephasing decay rate can be pre-determined and selected from the pre-determined value of dephasing decay rates for each SNR value. This may have the advantage that the dephasing decay rate does not have to be calculated for every peak in the spectrum and instead can be pre-determined which increases the speed of calculations and reduces the data processing requirements.

Optionally, the collisional decay rate may be pre-calibrated.

Optionally, the pre-calibration of the dephasing decay parameter may comprise calculating a plurality of dephasing decay parameters for a number of signal-to-noise, SNR, values; and fitting a curve to the plurality of dephasing decay parameters, such that a dephasing decay parameter can be determined for additional SNR values.

Optionally, a second ion of the plurality of ions has an identical collisional cross section to the first ion, such that a collisional decay parameter of the second ion is equal to a collisional decay parameter of the first ion.

Optionally, a correction factor and/or an initial amplitude may be calculated for the second ion using the collisional decay parameter of the first ion.

Optionally, a dephasing decay parameter or a correction factor may be calculated without calculating the collisional decay parameter.

Optionally, two or more ions of the plurality of ions may differ in their isotopic composition. For example, the ions may be isotopes or isotopocules. Therefore, the novel techniques described herein may be used for the analysis of isotope, isotopologue or isotopocule ratios.

Optionally prior to calculating the initial amplitude, the method may further comprise determining the collisional decay parameter of a second peak in the mass spectrum, wherein the second peak has an abundance above a threshold abundance; wherein the collisional decay parameter of the first peak is equal to the collisional decay parameter of the second peak. This may have the advantage that the collisional decay parameter does not need to be calculated for each peak, therefore reducing the processing needed.

Optionally prior to calculating the initial amplitude, the method may further comprise calculating the dephasing decay parameter of the first peak by using a logarithm of an inverse Fourier Transform of the first peak and the collisional decay parameter of the first peak.

Optionally calculating the initial amplitude of the transient signal may further comprise calculating a correction factor for the abundance, wherein the correction factor is calculated using the collisional decay parameter and the dephasing decay parameter. This may have the advantage that the abundance is corrected by taking into account the collisional and dephasing decay parameters. Therefore, the abundance of an ion can be corrected, and the initial amplitude found. The abundance is relative to the calculated SNR value, as ions with a higher abundance exhibit higher SNR due to their stronger signals. The correction factor may be used to improve accuracy, precision, repeatability, and general quality of quantitative or semi-quantitative analysis of one or more ions and/or isotopocules in the ion sample.

It will be appreciated that in the examples described herein, SNR could instead be replaced by another spectral parameter used as a measure for abundance, whilst still using the novel techniques described herein.

Optionally the method comprises calculating a plurality of dephasing decay parameters for a number of signal-to-noise, SNR, values and fitting a curve to the plurality of dephasing decay parameters, such that a dephasing decay parameter can be determined for additional SNR values. This may have the advantage that the dephasing decay rates do not need to be explicitly calculated for each SNR value and each peak in a spectrum.

In another aspect there is provided a computer program for determining an initial abundance of one or more of a plurality of ions in an ion sample being analysed by a Fourier Transform Mass Spectrometer, the computer program comprising instructions which, when the program is executed by a computer, cause the method to be performed according to any of the methods described herein.

In another aspect there is provided a Fourier transform mass spectrometer which is configured to perform any of the methods described herein.

Optionally the Fourier transform mass spectrometer is an orbital trapping mass spectrometer.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments and are incorporated in and constitute a part of this specification but are not intended as a definition of the limits of the invention. In the figures, each identical or nearly identical component that is illustrated in various figures is represented by a like numeral. For purposes of clarity, not every component may be labelled in every figure.

FIG. 1 shows a graph of resolution vs SNR;

FIG. 2 shows a flowchart of a method according to an embodiment;

FIG. 3 shows a flowchart of a method according to an embodiment;

FIGS. 4A-4C show three stages of a method for determining decay parameters;

FIG. 5 shows a graph of transient signals;

FIG. 6 shows a graph of the dephasing decay parameter (a) vs SNR;

FIG. 7A shows a theoretical spectrum;

FIG. 7B shows an experimental spectrum determined according to an embodiment;

FIG. 8 shows a diagram of an Orbitrap mass spectrometer; and

FIG. 9 shows a flowchart of a method according to an embodiment.

### DETAILED DESCRIPTION

The disclosure will now be described in relation to specific embodiments. The embodiments described herein are not intended to be limiting and are for illustrative purposes.

The methods described herein will be described in relation to ions in an ion sample. In some examples, where the ions are species which differ only in their isotopic composition (i.e. the ions are isotopocules). In such examples the analysis is aimed to perform the analysis of the ratio of these isotopocule intensities (isotope ratio analysis). In other words, to determine the isotope ratio measurements, complex molecules may be analysed which carry different isotopes in their chemical structure. The method may be carried out by analysing isotopomers, isotopocules, or isotopologues. Therefore, technical aspects described herein may be used for ions, isotopomers or isotopologues or any other quantitative analysis of ions in a sample.

In examples described herein, initial abundances of two or more isotopocules or isotopes may be calculated. Such initial abundances may be used to determine isotope ratios within an ion sample.

However, in other examples the initial abundance of an ion may be calculated (i.e. the initial abundance of ions in any given peak). In other words, the initial amplitude of one or more individual ion peaks may be calculated. In some examples, one or more ion peaks may be analysed, where the ions are not isotopes or isotopocules, or where the ratio of peaks is not of interest. Three non-limiting examples of uses for such a method are described now.

In a first example, the methods described herein may be used for quantitative analysis, e.g. for absolute or relative quantification of one or more ions in an ion sample. For example, this quantification may use internal or external standards or calibration. The internal standards may be isotopically labelled and added to a known concentration. The ratio of the compound in a sample to the added standard may be used to quantify the compound in the sample.

In a second example, the methods described herein may be used for untargeted semi quantitative analysis of multiple compounds. This may be done in metabolomics, or lipidomics or other studies. In these uses, a ratio of peaks is not calculated. Instead, the methods described herein may be performed on individual peaks within the mass spectrum. In other words, the method may comprise performing the inverse FT and fitting procedure, as described herein, for every single peak of interest in the spectrum and determine the decay rate or initial amplitude for every peak.

In a third example, the methods described herein may be used in soft labelling experiments. One or multiple compounds enriched in one or multiple heavy isotopes are introduced into a system (cell culture, bacteria, animal, human) and untargeted screening of a group of compounds is then performed quantifying the peaks of the isotope label in these compounds to see how much the initial compound was incorporated into the organism. The transient decay in FT MS may be defined by two factors. First, the number of oscillating ions may decrease due to collisions of the ions with the background gas molecules. Second, the ions with same m/z may oscillate with somewhat different frequencies if trapped in a non-ideally isochronous ion trap. With the phase difference between the ions increasing over time, the partial contributions to the signal may add up to a smaller amplitude than in the beginning of the transient, when all phases were aligned.

Based on theoretical and experimental examination of signal decay in FTMS (and especially Orbitrap (RTM) mass spectrometers), it has been recognised that ions experience a number of space charge related effects. One of these effects is the so-called “self-bunching” which is the effective synchronization of all of the same m/z ions, due to the Coulombic interaction between them. In other words, the “natural” broadening of an ion packet is suppressed at high ion populations due to the combined action of space charge and electric field non-linearity.

It has been recognised that due to self-bunching, the dephasing mechanism of signal decay may not be present. Therefore, when the number of ions in a peak is greater than a certain self-bunching threshold, the signal may not decay due to dephasing decay.

Although the actual number of ions in a packet may be difficult to establish, it may be proportional to SNR of a peak at a given transient duration and decay constant, with the coefficient of proportionality dependent only on thermal noise of the preamplifier of the detector and its frequency dependence. The relationship between SNR and ion number is described in, for example, section 2.1 of Eiler et al. (Analysis of molecular isotopic structures at high precision and accuracy by Orbitrap (RTM) mass spectrometry (International Journal of Mass Spectrometry, Volume 422, 2017, Pages 126-142, ISSN 1387-3806)), which is incorporated herein by reference. The relationships for determining ion number described in Eiler et al. can be used in embodiments of the present disclosure whenever signal intensities or SNR are described as being used.

The signal decay may be estimated from the mass spectrum using the observed peak width. The resolution may be indicative of or proportional to temporal signal loss, and SNR may be equivalent to or proportional to the size of the ion population in a cloud. Therefore, in the description of novel concepts below, SNR may be used to refer to the population, i.e. abundance, of ions in an ion sample.

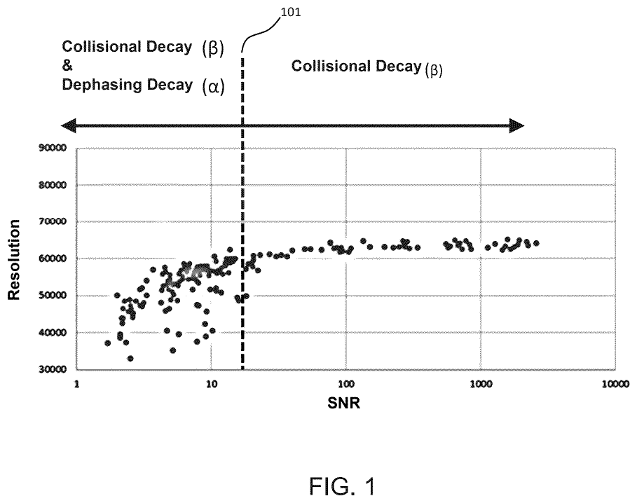

FIG. 1 shows that for ion packets with an ion population greater than a threshold (referred to herein as the self-bunching threshold) the decay rate may be entirely determined by collisional decay. The threshold is shown by the dotted line labelled 101 in FIG. 1. The self-bunching threshold may be at an SNR value of around 80. It will be appreciated that the same concepts described herein apply to examples in which isotopocule populations are determined.

Ions may decay due to collisional decay. This collisional decay arises due to the collisions between the ions and background gas molecules and is preserved for a given ion species under consistent pressure conditions. In other words, the collisional decay may be approximately constant for a given ion species (i.e. all isotopic states of a chemical compound) and can be precisely calculated. Therefore, the collisional decay rate (also referred herein to as the collisional decay parameter) determined for one isotopocule in the ion sample is equal to the collisional decay rate of another isotopocule in the same ion sample. The decay caused by collisions provides information about the ionic collisional cross-section (CCS), since ions with higher CCS are expected to collide with background gas more frequently and hence the image signals provided by such ions are expected to decay more rapidly. The collisional decay also provides information about the pressure within the analyser.

As shown in FIG. 1, for ions with abundances below the self-bunching threshold (i.e. the ion peak has an amplitude below the self-bunching threshold), the decay comprises components of dephasing decay and collisional decay. It has been recognised that the collisional decay rate (β) and the dephasing decay rate (α) can be separated. The dephasing decay arises due to the spectrometer's non-ideality, i.e. imperfections in the spectrometer, and provides no useful information about the CCS. The rate of dephasing decay is different for most ions, and it may be different for most isotopes (and isotopocules). Most molecules have multiple non-monoisotopic (non M0) peaks where each peak may be for one or more isotopes of the molecule. Due to the different relative abundances of heavy isotopes, different isotopocules exist in the FTMS analyser at different abundances. Therefore, each isotopocule has its own individual rate of dephasing. Therefore, in some methods described herein, the dephasing decay rate is determined for each peak. In a mass spectrum in which there is a plurality of peaks, the peaks may relate to isotopes of the same molecule, or the peaks may relate to different ions (i.e. ions of different molecules). In other words, the peaks may not relate to isotopes.

It will be appreciated that the following description will be in relation to ions, wherein one or more ion peaks may be considered individually. However, the same concepts apply to examples in which multiple isotopic peaks are analysed to calculate the isotopic ratio within an ion sample. As will be described, it has been appreciated that the dephasing decay parameter can be calculated and used in combination with the collisional decay parameter to provide an improved accuracy of the measurement of the abundance of an ion (or isotopocule) within an ion sample. Using the decay parameters, it is possible to find the abundance of the ions before ions decay due to collisional decay and/or dephasing decay.

As described herein, the intensity of the induced current (which is indicative of the abundance of an ion) decreases with time as the ions are fragmented upon collisions with the gas molecules or pushed to the unstable orbits, where they quickly decay. The cloud also loses its coherence as a result of the dephasing.

The function of intensity over time can be expressed as shown in equation 1, wherein the intensity decreases with time.

$$I ( t ) = {e}^{- γ ( t )} , \qquad ( 1 )$$

Where t is the time of a transient, and γ is a rate of decay. In particular, γ is the sum of the rates of collisional (β) and dephasing (α) decay, where γ increases with time t. The equation 1 can be re-written as in terms of the collisional dephasing decay, as shown in equation 2:

$$I ( t ) = {e}^{c - α ( t ) - β ( t )} \qquad ( 2 )$$

The stochastic collisional decay obeys the Poisson distribution, which results in a linear term −βt. The dephasing component α(t) is generally non-linear. In the case that the ion packet was initially strictly phased (all ions start oscillation with one phase), the function α(t) is expected to have a zero slope at t=0, and the minimal-complexity model for it is a quadratic function αt², resulting in equation 3:

$$I ( t ) = {e}^{c - α {t}^{2} - β t} \qquad ( 3 )$$

The coefficient c gives the intensity at t=0 as I₀=I(0)=e^{c} which is proportional to the number of ions in a peak.

In frequency, or equivalently in m/z, domain the intensity of the observed peak may be suppressed. And the overall drop in the observed peak intensity in the course of the transient of the duration T can be determined by equation 4. This can be referred to as the correction factor. The correction factor enables a corrected SNR to be determined, wherein, as described herein, the SNR is related to the abundance. Equation 4 may be used to calculate the correction factor, and time T is the length of the transient, i.e. the length of the analysis. For example, this may be 1.024 seconds for a 480,000 resolution measurement. Where “erf” is the error function defined by

$$erf ( z ) = \frac{2}{\sqrt{π}} {\int }_{0}^{z} {e}^{- {t}^{2}} dt .$$

$$correction factor = \frac{1}{T} {\int }_{0}^{T} {e}^{- α {x}^{2} - β x} d x = \frac{\sqrt{π} {e}^{\frac{{β}^{2}}{4 α}} ( erf ( \frac{β + 2 T α}{2 \sqrt{α}} ) - erf ( \frac{β}{2 \sqrt{α}} ) )}{2 T \sqrt{α}} \qquad ( 4 )$$

Therefore, as will be described, using the approach described herein, it is possible to determine the original intensity value (i.e. at the timepoint T=0) if the values for α and β are known.

Therefore, if the collisional decay parameter, β, and the dephasing decay parameter, α, are known, the initial intensity may be determined using equation 4.

The initial abundance may be calculated by dividing the decayed abundance, i.e. the abundance at time T, by the correction factor calculated according to equation 4.

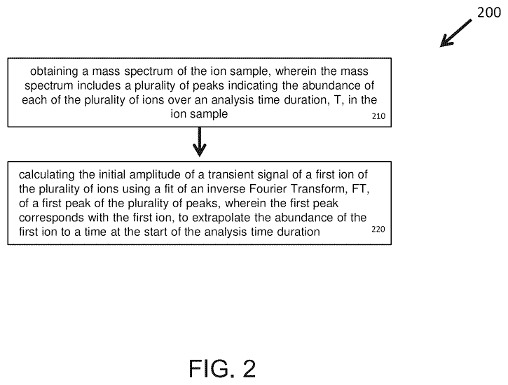

FIG. 2 illustrates a method 200 according to an example. The method determines the initial abundance of one or more of a plurality of ions in an ion sample. The ion sample is being analysed by a Fourier Transform Mass Spectrometer. As described herein, due to collisional and dephasing decay, the plurality of ions (i.e. the abundance of ions) decays over time during the analysis. Therefore, the measured analysis at time T does not accurately provide the initial abundance of ions (i.e. the abundance of each type of ion) in an ion sample.

In step 210 a mass spectrum is obtained of an ion sample. The mass spectrum provides the intensity (i.e. abundance) against mass to charge ratio (m/z) of ions within the analysed ion sample. The intensity is indicated over an analysis time T. As described herein, the intensity shown on the mass spectrum may change with time, as ions decay due to collisional and/or dephasing decay. Each peak on the mass spectrum relates to an ion, i.e. each peak on the mass spectrum relates to molecules with the same m/z ratio. The mass spectrum may comprise more than one peak, for example when the ion sample comprises isotopocules or isotopes.

In step 220 an initial amplitude of a transient signal (i.e. an initial signal amplitude) of a first ion is calculated. The transient signal represents the intensity or abundance of ions at specific mass to charge ratios over time. The initial amplitude of the transient signal of a first ion therefore provides quantitative information about the first ion, i.e. about an ion of interest. The initial amplitude provides information about the abundance or intensity of the first ion at an initial time, i.e. before ions have decayed. Therefore, the initial amplitude of the transient signal for each ion provides the abundance of the respective ions within the ion sample before the ion sample has undergone mass analysis. In the example method 200 the initial amplitude of the transient signal of a first ion is calculated using a fit of an inverse Fourier Transform of a first peak of the plurality of peaks. The first peak corresponds to the first ion. The fit of the inverse Fourier Transform is used to extrapolate the abundance of the first ion to a time at the start of the analysis time duration (i.e. to the start of the analysis). In other words, the abundance is extrapolated to a time at the start of the analysis time duration.

In the example in which the mass spectrum comprises two or more peaks, the method may comprise individually calculating an initial amplitude for each of the ion peaks.

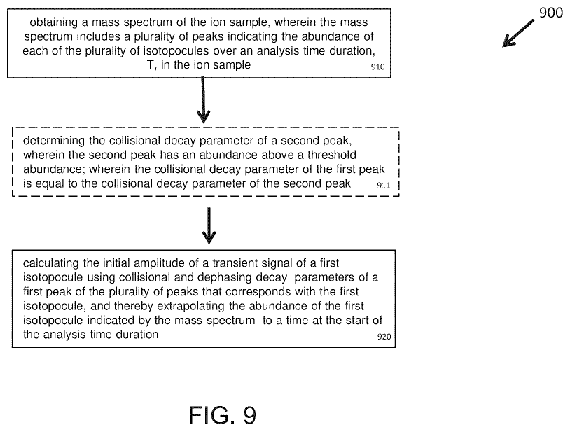

In another example, described in relation to FIG. 9, a plurality of peaks may be analysed, wherein the peaks correspond to one or more isotopes or isotopocules.

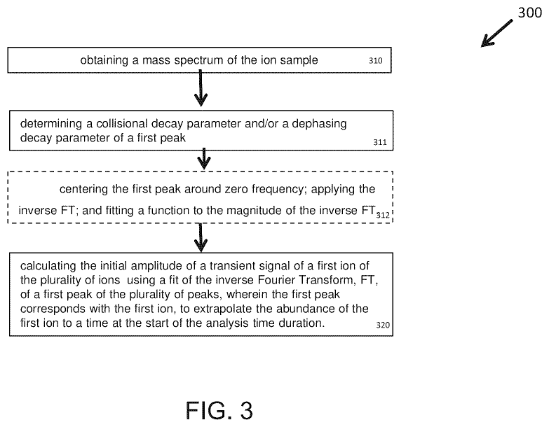

Another example method 300 for determining the initial abundance of an ion is described in relation to FIG. 3.

Step 310 comprises obtaining a mass spectrum of an ion sample. This step may be the same step as 210, such that the step 310 has the same features as step 210.

Step 311 comprises determining a collisional decay parameter and/or a dephasing decay parameter. Methods for determining a collisional decay parameter and/or dephasing decay parameter are described herein, and any of such methods may be used herein. For example, as shown by step 312, the first peak, i.e. the peak being analysed, is centred around zero frequency, and an inverse Fourier transform (FT) is applied to the peak. A suitable function is then fitted to the magnitude of the inverse FT. By fitting a function to the magnitude of the inverse FT, it is possible to determine the collisional decay parameter and/or the dephasing decay parameter. In some examples, a function may be fitted to the logarithm or natural logarithm of the inverse FT to determine the collisional decay parameter and/or the dephasing decay parameter. This method is described in more detail herein.

In some examples, such as in an example in which abundance of one or more isotopocules is being calculated, the initial amplitude may instead, or additionally be calculated using collisional and dephasing decay parameters of a first peak of the plurality of peaks (which corresponds to the method described in FIG. 3). In this example the first peak corresponds with the first isotopocule. Using these decay parameters, the abundance of the first isotopocule may be extrapolated to a time at the start of the analysis time duration. It has been appreciated that the abundance or intensity decays over time during the analysis due to collisional and/or dephasing decay. Therefore, the initial decay can be calculated using the collisional and dephasing decay parameters of the first isotopic peak, where the dephasing decay parameter may be zero. The collisional decay parameter may be substantially the same for each isotopocule, and the dephasing decay parameter may vary for each isotopocule.

Therefore, in such an example, it has been appreciated that by using the approach described herein, it is possible to determine the initial abundance of an isotopocule in an ion sample using both of dephasing decay parameter and the collisional decay parameter. It is therefore possible to determine an initial abundance for isotopocules with abundances above or below a self-bunching threshold, as described in more detail herein.

An example method 900 further describes the example in which initial abundance of an isotopocule is calculated. The method 900 may comprise any of the features described in relation to method 200, or may be combined with any of the features of method 200 or 300. It will be appreciated that in this example the mass spectrum comprises a plurality of peaks, wherein two or more of the plurality of peaks correspond to isotopocules, i.e. the peaks are isotopic peaks.

Step 910 comprises obtaining a mass spectrum of an ion sample. This step may be the same step as 210, such that the step 910 has the same features as step 210. The mass spectrum, in this example, includes a plurality of peaks indicating the abundance of each of the plurality of isotopocules over an analysis time duration, T, in the ion sample.

Step 911 is an optional step, which comprises determining the collisional decay parameter of a second peak. The second peak corresponds to a second isotopocule within the same ion sample as the first isotopocule. In this example, the second isotopocule has an abundance above a threshold abundance. In other words, the SNR of the second isotopocule is greater than the threshold described herein. The threshold abundance is determined by the threshold at which self-bunching occurs for the isotopocule, due to the coulombic effect. Therefore, the threshold abundance may also be referred to as the self-bunching threshold. Isotopocules which have a threshold above the self-bunching threshold do not decay due to dephasing. Therefore, it has been appreciated that by considering a second isotopocule which has an abundance above the threshold abundance, it can be determined (or it can be approximated) that the decay of the second isotopocule during mass analysis is only due to collisional decay.

The collisional decay parameter of the first peak is equal, or substantially equal, to the collisional decay parameter of the second peak. It has been appreciated that the collisional decay parameter is approximately the same for all isotopic states of a chemical compound. Therefore, it is realised that the collisional decay parameter which has been determined for the second peak can also be used as the collisional decay parameter for the first isotopocule, where the first isotopocule may have an abundance which is above or below the threshold.

Step 920 can either follow step 910, or step 911. At step 920 the initial amplitude of the transient signal of the first isotopocule can be calculated using collisional and dephasing decay parameters of a first peak of the plurality of peaks that corresponds with the first isotopocule and thereby extrapolating the abundance of the first isotopocule indicated by the mass spectrum to a time at the start of the analysis time duration. The parameters determined in step 911 or according to any of the methods described herein, may be used to calculate the initial amplitude of the transient signal.

Therefore, by using the method 900 described in relation to FIG. 9, the initial abundance of a first isotopocule may be calculated. The method provides an efficient way to calculate such an abundance as it has been appreciated that the dephasing decay and the collisional decay may be separated, and that the collisional decay may be the same for isotopocules of the same chemical compound. It will be understood that the method for determining the initial abundance of each isotopocule in the sample can instead be the method described in relation to step 220, i.e. an inverse Fourier transform.

As discussed above, the dephasing decay parameter is labelled herein as a, and the collisional decay parameter is labelled herein as β. The intensity can be projected, i.e. extrapolated, to its original value at timepoint t=0 using the collisional and/or dephasing decay parameters.

If the dephasing and collisional decay parameters are known, the initial amplitude can be calculated by determining a correction factor, wherein the correction factor is based on the collisional and dephasing decay parameters. As described herein, equation 4 may be used to calculate the correction factor, where time Tis the length of the transient, i.e. the length of the analysis. Therefore, if the collisional decay parameter, β, and the dephasing decay parameter, α, are known, the initial intensity may be determined, for example by using equation 4.

The corrected SNR (which is relative to the corrected abundance) may be calculated according to equation 5, wherein the decayed SNR, i.e. the SNR at time T, is divided by the correction factor (calculated according to equation 4).

$$S N {R}_{c o r rected} = \frac{S N R}{correction factor} \qquad ( 5 )$$

### Calculating the Decay Parameters at the Same Time

An example method for determining the dephasing and collisional decay parameters will now be described. However, it will be appreciated that other methods for determining either or both of these parameters may be used without departing from the approach described herein. These methods may be used in any of methods 200, 300 and/or in method 900 described herein.

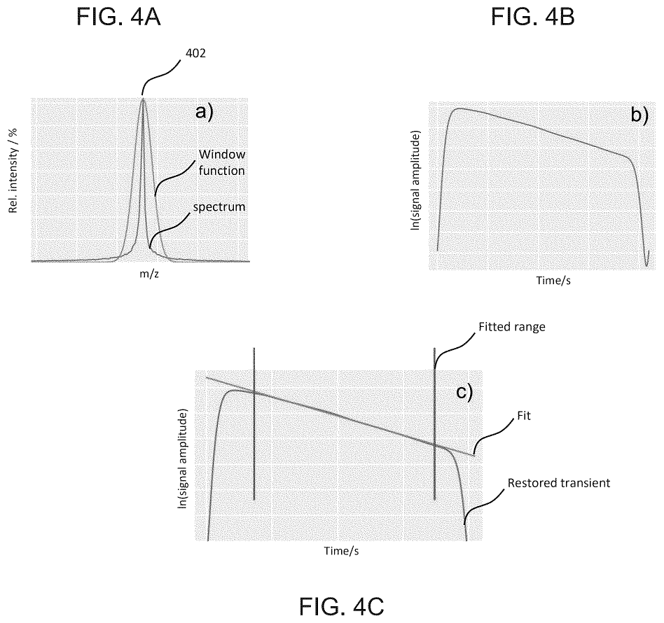

FIGS. 4A, 4B and 4C illustrate an example method for determining the collisional decay parameter β and the dephasing decay parameter α. The method is shown using the three FIGS. 4A, 4B and 4C. For the method described in relation to these figures, raw transient data is required, to enable the parameters to be determined by the described method.

Firstly, in FIG. 4A, a spectrum is shown for an ion. The peak 402 (i.e. spectral peak) of interest is separated from the other peaks in the mass spectrum. The peak may be isolated from the other peaks in the spectrum by using a smooth function. FIG. 4A shows the application of the smooth function, wherein the inner line corresponds to the original spectrum, and the outer line corresponds to smoothing function, e.g. the window function. However, it will be appreciated that the peak may be isolated from the other peaks by another suitable method.

After the selected peak has been isolated, it is centred around zero frequency, and an inverse Fourier transform is applied. FIG. 4B shows the logarithm of the inverse of the Fourier transform signal amplitude (of the peak shown in FIG. 4A) plotted against the time of the transient. As described herein, the inverse Fourier transform may be used to determine the initial abundance of an ion or isotopocule.

A linear regression may be fitted to the inverse Fourier Transform. In one example, to determine α and β, equation 3 may be fitted to the result of the inverse Fourier transform (FT). The equation may be fitted to the inner part of the curve, which is artifact free, as shown in FIG. 4C. The equation may be fitted in the linear range, wherein this range is shown between the two vertical lines shown in FIG. 4C.

Alternatively to the method shown in FIG. 4C, i.e. instead of fitting equation 3 to the curve, a polynomial −αt²−βt−c may be fitted to the logarithm of the magnitude of the result of the inverse FT (not shown in FIG. 4C).

The coefficient c gives the intensity at t=0 as I₀=I(0)=e^{c} which is proportional to the number of ions in a peak. Therefore, by fitting a suitable polynomial, the coefficient c may be determined, as well as α and β being determined. Therefore, α and β (and optionally c) may be determined at the same time using the method described above. However, simultaneous evaluation of both α and β parameters from the observed signal (be it transient or spectrum) is not always reliable because of the noise and the end-interval artifacts of the inverse FT. Therefore, it is advantageous to provide a method in which the parameters are not evaluated at the same time.

### Calculating the Decay Parameters Independently

In another example, in which there are two or more isotopic peaks within the mass spectrum, the collisional decay rate may be determined by analysing an isotopocule which has an abundance above an abundance threshold. In one example the abundance threshold is around a SNR of 80. The abundance threshold is the abundance above which there is no dephasing decay due to self-bunching, as described herein. The threshold may be a pre-determined threshold. Therefore, by analysing the isotopocule above the threshold it is determined that the isotopocules only decay due to collisional decay. The collisional decay parameter can be calculated using linear regression. In particular, the collisional decay follows a first order exponential decay, and therefore when there is no dephasing decay, the collisional decay can be calculated using linear regression on the logarithm of the magnitude of the inverse Fourier transform. In particular the collisional decay parameter may be determined using equation 3, described herein.

It has been appreciated that for isotopocule peaks obtained under similar conditions (e.g. similar gas pressure, acceleration voltage, etc.), the collisional cross-section is substantially the same. Therefore, the collisional decay parameter is substantially the same for isotopocules, i.e. we can estimate that the isotopocules have the same collisional decay rate. Therefore for isotopocules with abundances above the threshold, the isotopocules decay at substantially the same rate, as there is no dephasing decay.

After calculating the collisional decay parameter in isolation, the same method as described in relation to FIGS. 4A, 4B, 4C can be used to determine the dephasing decay parameter, α. For example, equation 3 may be fitted to the inverse Fourier transform, or a second order polynomial may be fitted to the magnitude of the inverse Fourier transform (or the logarithm of the magnitude of the inverse Fourier transform). For example, polynomial −αt²−βt−c may be used to determine the dephasing decay parameter α. By calculating the collisional decay parameter before determining the dephasing decay parameter, by using any of the methods described herein so that the parameter β is known, the fitting procedure can be used to determine only the dephasing decay parameter α. Therefore, the dephasing decay parameter can be determined independently of the collisional decay parameter. Once the collisional decay parameter and the dephasing decay parameter have been determined, the initial abundance can be calculated. This provides an improved method of determining the decay parameters, and therefore the initial abundance of the isotopocule. By determining β using a high abundance peak, the calculation of β will be more precise and accurate than calculating β using a low abundance peak, as the high abundance peak will be less affected by noise and has no dephasing decay. Using this more precise β value to calculate α will result in a more precise calculation of α. Therefore, this method provides a more accurate and precise calculating of the decay parameters.

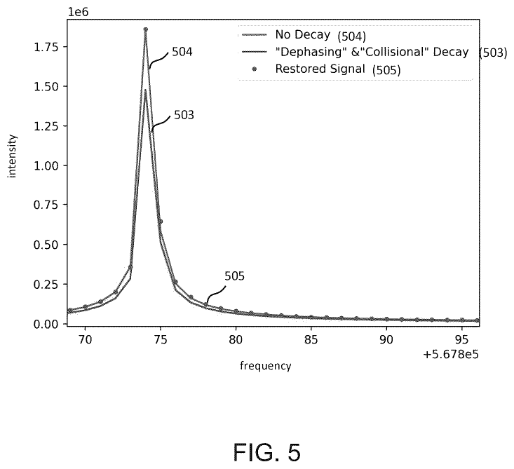

FIG. 5 illustrates a frequency spectrum of a single peak. In this graph, intensity is plotted versus frequency. The frequency can be converted into mass-to-charge (m/z) ratio (not shown here) to provide a mass spectrum. The graph shows an Orbitrap (RTM) transient signal of a cloud consisting of monoisotopic MRFA ions (Methionine, Arginine, Phenylalanine, Alanine ions) of charge z=1 which is simulated with the assumed dephasing and collisional decay rates of α=0.495 and β=0.3 respectively. The graph shows a transient signal 503 which includes a decay, i.e. the signal has been reduced due to ions decay over time. Therefore, the abundance of the ions has decreased over time, and does not show the initial abundance of the ions in the ion sample. The graph also shows transient signal 504 which does not have any decay, i.e. this signal illustrates the initial amplitude of the transient signal, as described herein. Therefore, the transient signal without any decay shows the initial abundance of the ions in the sample. FIG. 5 also illustrates a ‘restored’ transient signal 505, i.e. the decayed signal of FIG. 5 has been extrapolated to determine the initial intensity, using the collisional decay parameter and the dephasing decay parameter, according to the present invention. As shown, the non-decaying signal 504 has a higher intensity than the decayed signal 503. For example, the non-decaying signal has a maximum intensity of around 2e6, whereas the decayed signal has a maximum intensity of around 1.5e6. The restored signal is shown by the data points 505, and it is shown that the restored signal has an intensity restored to approximately the intensity of the non-decayed signal. Therefore, it is shown that by using the techniques described herein, it is possible to determine the abundance of ions in an ion sample, i.e. before any decay has taken place. The same is true for the determination of an abundance of isotopocules. It will be appreciated that there may be some corruption due to simulated noise which may result in the restored signal not having the exact same intensity as the non-decayed signal. However, as shown by the figure, the method provides an accurate extrapolation of the signal to account for the decays found in Fourier transform mass spectrometry.

### Pre-Calibrated Parameters

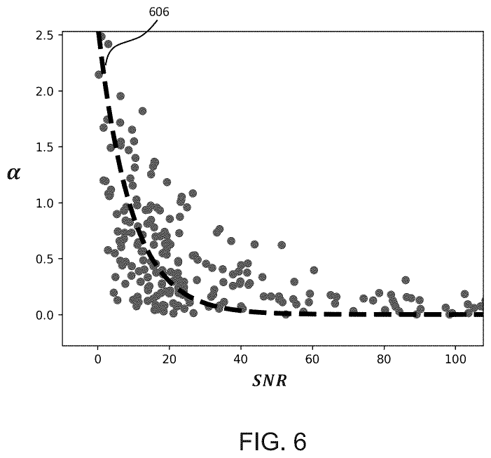

In the examples described herein, it is possible to pre-calibrate the values of the dephasing decay parameter. FIG. 6 shows a graph of dephasing decay parameter along the y axis, and SNR along the x axis. It has been appreciated that the rate of dephasing is reproducible for packets with the same ion population, where the ion population is associated with the SNR. Therefore, the rate of dephasing is reproducible for ions or isotopocules with the same SNR. As shown in FIG. 6, data can be collated for the calculated dephasing decay rate at different SNR values. In other words, the dephasing decay rate is determined for a plurality of SNR values, wherein the plurality of SNR values are different, such that the dephasing decay rate is determined for a range of SNR values. The dephasing decay rate may be determined using one of the methods described herein, for example the method described in relation to FIGS. 4A, 4B, 4C. A smooth function can be fitted through the calculated plurality of dephasing decay rates, and an equation can be determined which fits the function. Therefore, an equation can be determined which provides the relationship between SNR and the dephasing decay rate. Therefore, a dephasing decay rate can be determined for isotopocules at additional SNR values, i.e. isotopocules with SNR values for which the dephasing decay rate has not been explicitly calculated.

One example of a smooth function, which is shown as a dotted line on FIG. 6, is provided by equation 6. Equation 6 provides a relationship between the dephasing decay parameter and the SNR value.

$$A ( S N R ) = A {e}^{- b * S N R} \qquad ( 6 )$$

As shown in equation 6, the dephasing decay parameter may be provided by an exponential function. The parameters A and b may be determined by fitting equation 6 to the smooth function. Once the parameters A and b have been calculated using the fitted curve, the relationship between the dephasing decay parameter and SNR can be determined. Therefore, the dephasing decay rate can be accurately determined for isotopocules (or ions) at any SNR value, using the fitted curve, and/or the equation 6.

As described above in relation to equation 4, once the collisional decay parameter and the dephasing decay parameter have been calculated, the method may then calculate the corrected SNR value (i.e. the initial abundance) for each isotopocule. As described herein, the corrected initial amplitude may be calculated using equation 7:

$$S N {R}_{c orrected} = \frac{S N R}{correction factor} \qquad ( 7 )$$

wherein the correction factor is calculated using equation 4. The reader is referred to the disclosure described in relation to equation 4, whose features may be combined with the example method described here.

The collisional decay rate can be pre-calibrated (i.e. pre-determined). The collisional decay rate may be pre-calibrated in addition to or in isolation to the dephasing decay parameter being pre-calibrated. The collisional decay rate, β, can be pre-calibrated by analysing the compound, molecule, or ion of interest at higher signal to noise ratios (SNRs). As shown in FIG. 6, at an SNR above around 80, the dephasing decay rate, α, is around 0. Therefore, as described above, equation 3 can be used to determine β, when it is approximated that the dephasing decay rate is 0. Therefore, the collisional decay rate can be pre-calibrated such that the collisional decay rate can be pre-determined for ions with the same collisional cross section. Multiple data points may be acquired for the same SNR value to improve the accuracy of the determined collisional decay parameter, however it is not necessary to acquire data at different SNR values. Furthermore, as described herein, it is approximated that the collisional decay rate is the same for all isotopic states of a chemical compound. Therefore, by determining the collisional decay parameter using linear progression, and using a pre-calibrated dephasing decay parameter, it is possible to determine both decay parameters for isotopic peaks, and thus the initial abundance (i.e. intensity) of each isotopocule in an ion sample can be determined with uncorrupted decay intensities, using equation 4.

In some examples, as an alternative to determining the values of α and β for different SNR values, and fitting a curve through the results, the values of β and α may be estimated directly. Instead of determining specific SNR values, the resolution may be plotted against SNR, as shown in FIG. 1. As shown in FIG. 1, above an SNR value, the isotopocules only decay due to collisional decay. Therefore, the values of α and β can be estimated from the graph of resolution vs decay, rather than requiring α and β to be determined individually for a number of SNR values. It will be appreciated that this provides an estimated value only but does not require the use of an inverse Fourier transform and the transient and therefore may require less processing.

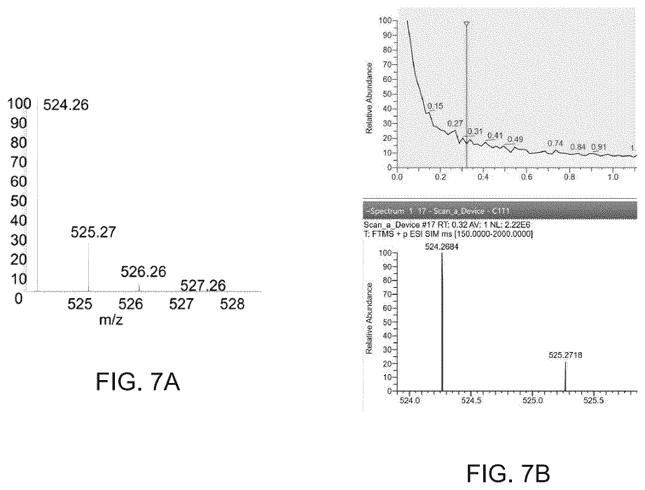

FIG. 7A illustrates a theoretical spectra and FIG. 7B illustrates an experimentally obtained spectra. In the experiment, to obtain the spectra shown in FIG. 7B, a set of experimental MRFA, z=1 spectra were acquired on a research grade Orbitrap Exploris (RTM) system. The resolution was set to 480 k @ m/z=200; the injection time was ramped to ensure that the peaks have different ion populations. The collisional decay rate β=0.3 s⁻¹ was calculated for the self-bunched species (where the self-bunching threshold is 20), the coefficients for the equation 6 were obtained via least square fitting: A=2.58 and b=0.11.

FIG. 7A shows the theoretical MRFA spectrum with the theoretical ratio of isotopes (or isotopocules) M1/M0=25.52%. Isotopic peaks M0, M1, M2, and M3 are shown in FIG. 7A.

The experimental spectrum (FIG. 7B) shows the significant suppression of the M1 peak with the M1/M0=18.54%, where the peaks M1 and M0 are labelled in FIG. 7B. The cause of the discrepancy may be that the M0 peak is abundant enough to enforce the space-charge-related self-bunching. The SNR of the monoisotopic peak (M0) is 26.55, which is above the self-bunching threshold (SNR>20), therefore the isotopes of the M0 peak do not decay due to dephasing, and therefore the dephasing rate α_{M0}=0. However, the M1 peak is much less abundant, and is subject to dephasing decay. The SNR of M1 isotope is 4.92, which according to eq. 3, results in the dephasing rate α_{M1}=1.50 s⁻². Correcting for the temporal signal loss by using the values for α and β parameters in equation 4, which results in the isotope ratio M1/M0_{corrected}=26.02%. Therefore, this experimentally obtained isotope ratio M1/M0_{corrected} using the methods described herein is a good approximation of the theoretical value given spectral noise level.

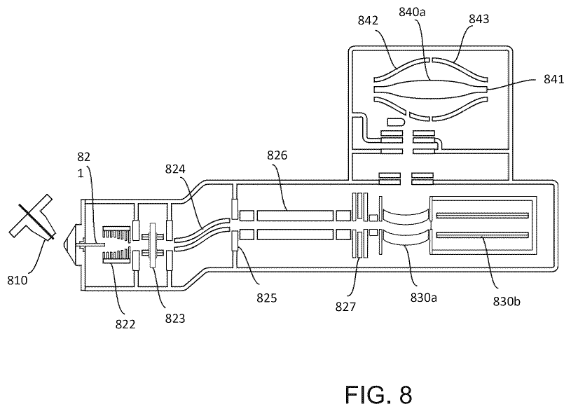

FIG. 8 shows an example mass spectrometer that may be operated in accordance with embodiments described herein. The mass spectrometer may be the mass spectrometer described with reference to FIG. 2 of US 2023/0282471A1, which is incorporated by reference herein.

In the example mass spectrometer, the instrument's ion source 810 is an electrospray ionisation (ESI) ion source. The instrument includes a vacuum interface, which includes a transfer tube 821, an ion funnel 822, a quadrupole pre-filter ion guide 823, and a “bent flatapole” ion guide 824. The bent flatapole ion guide 824 may be of the design described in U.S. Pat. No. 9,536,722, the entire contents of which are incorporated herein by reference.

The instrument also includes a mass filter in the form of a quadrupole mass filter 826, an ion trap 830a in the form of a curved linear ion trap (“C-Trap”), and a collision cell 830b in the form of an ion routing multipole collision cell (“IRM”). Ions from the ion source 810 can be accumulated in the C-Trap 830a and/or collision cell 830b by opening and closing a gating electrode located in a charge detector assembly 827, which is arranged between the C-Trap 830a and the mass filter 826.

The instrument also includes a mass analyser 840 a in the form of an orbital ion trap mass analyser. As shown in FIG. 8, the orbital trap 840a comprises an inner electrode 841 elongated along the orbital trap axis and a split pair of outer electrodes 842, 843 which surround the inner electrode 841 and define therebetween a trapping volume in which ions are trapped and oscillate by orbiting around the inner electrode 841 to which is applied a trapping voltage whilst oscillating back and forth along the axis of the trap. The pair of outer electrodes 842, 843 function as detection electrodes to detect an image current induced by the oscillation of the ions in the trapping volume and thereby provide a detected signal.

The outer electrodes 842, 843 typically function as a differential pair of detection electrodes and are coupled to respective inputs of a differential amplifier (not shown in FIG. 8), which in turn forms part of a digital data acquisition system to receive the detected signal. The detected signal can be processed using Fourier transformation to obtain a mass spectrum of ions within the trap.

Once accumulated in the ion trap 830a and/or collision cell 830b, ions can be ejected into the mass analyser 840a. To do this, the ions may be ejected from the trap 830a in a direction orthogonal to the axis of the trap (orthogonal ejection), for example by applying one or more suitable DC voltages to the ion trap 830a. The ions may be injected into the mass analyser 840a via one or more lenses and a deflector electrode. The mass analyser 840a is arranged downstream of the ion trap 830a and is configured to receive ions from the ion trap 830a (via the one or more lenses and the deflector electrode).

The collision or reaction cell 830b is arranged downstream of the ion trap 830a. Ions collected in the ion trap 830a can either be ejected orthogonally to the mass analyser 40 a without entering the collision or reaction cell 830b, or the ions can be transmitted axially to the collision or reaction cell 830b for processing before returning the processed ions to the ion trap 830a for subsequent orthogonal ejection to the mass analyser 840a. The processing may comprise, for example, fragmenting the ions by collisions with a collision gas and/or a reagent in the collision cell 830b, or further cooling the ions by collisions with a gas at lower energies that do cause the ions to fragment.

A typical Fourier transform mass spectrometry experiment comprises of ionising the ion sample, selecting the species (i.e. ions) of interest, optionally fragmenting the ions, and introducing the ions (either fragmented or not fragmented) into the analyser. Ions trapped within the mass analyser may oscillate with a frequency which may depend on their mass-to-charge ratio and which can be detected using image current detection. The ions may perform substantially harmonic oscillations along the axis in an electrostatic field whilst orbiting around the inner electrode. As the ions oscillate inside the detector they induce image current on the detection plates. In the example mass spectrometer of FIG. 8, the pair of outer electrodes 842 and 843 function as detection electrodes to detect an image current induced by the oscillation of the ions in the trapping volume and thereby provide a detected signal. The outer electrodes 842, 843 typically function as a differential pair of detection electrodes and are coupled to respective inputs of a differential amplifier (not shown in FIG. 8), which in turn forms part of a digital data acquisition system to receive the detected signal. The detected signal is amplified, digitized, and stored as a transient signal. The transient is then converted to a mass spectrum via a Fourier transform.

Alternative methods or apparatus may be used with the techniques described herein to determine an initial abundance of ions in an ion sample. For example, the novel techniques could be used in orbital trapping mass spectrometer as described herein, as well as in FT-ICR, without departing from the scope of the invention.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

It will be appreciated that there is an implied “about” prior to temperatures, concentrations, times, pressures, flow rates, cross-sectional areas, voltages, currents, etc. discussed in the present teachings, such that slight and insubstantial deviations are within the scope of the present teachings. Furthermore, values referred to as being “equal” may in fact differ by less than a threshold amount. The threshold amount may be 5%, for example. The threshold may also be greater than 5% (for example, 10%, 20% or 50%) or less than 5% (for example, 2% or 1%).

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as an electrode) means “one or more” (for instance, one or more electrodes).

Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the invention. That is, an element termed a “first” element may instead be termed a “second” element) and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described herein, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

In this detailed description of the various embodiments, for the purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the scope of the various embodiments disclosed herein.

Unless otherwise described, all technical and scientific terms used herein have a meaning as is commonly understood by one of ordinary skill in the art to which the various embodiments described herein belongs.

We claim:

1. A method for determining an initial abundance of one or more of a plurality of ions in an ion sample being analysed by a Fourier Transform Mass Spectrometer, the plurality of ions decaying over time during the analysis, the method comprising:
obtaining a mass spectrum of the ion sample, wherein the mass spectrum includes a plurality of peaks indicating the abundance of each of the plurality of ions over an analysis time duration T in the ion sample; and
calculating an initial amplitude of a transient signal of a first ion of the plurality of ions using a fit of an inverse Fourier Transform (FT) of a first peak of the plurality of peaks, wherein the first peak corresponds with the first ion, to extrapolate the abundance of the first ion to a time at a start of the analysis time duration T.

2. The method of claim 1, wherein the method further comprises:
determining a collisional decay parameter and/or a dephasing decay parameter of the first peak.

3. The method of claim 2, wherein determining the collisional decay parameter and/or the dephasing decay parameter of the first peak comprises:
centering the first peak around zero frequency;
applying the inverse FT; and
fitting a function to the magnitude of the inverse FT.

4. The method of claim 3, wherein the function is a linear regression.

5. The method of claim 2 wherein the determination of the collisional decay parameter and/or the dephasing decay parameter comprises fitting a polynomial −αt²−βt−c to the logarithm of the magnitude of the inverse FT, wherein α, β, and c are real numbers and t is time.

6. The method of claim 5, wherein an initial amplitude I₀ of the transient signal of the first ion is calculated from parameter c, wherein I₀=I(0)=e^{c}.

7. The method of claim 1, wherein calculating the initial amplitude of the transient signal further comprises calculating a correction factor for the abundance, wherein the correction factor is calculated using a collisional decay parameter and a dephasing decay parameter.

8. The method of claim 7, wherein the correction factor is calculated as
$$\frac{1}{2 T} \sqrt{\frac{π}{α}} {e}^{\frac{{β}^{2}}{4 α}} ( erf ( \frac{β + 2 T α}{2 \sqrt{α}} ) - erf ( \frac{β}{2 \sqrt{α}} ) ) ,$$
wherein α is the dephasing decay parameter, and β is the collisional decay parameter.

9. The method of claim 1, wherein a dephasing decay parameter is pre-calibrated.

10. The method of claim 9, wherein the pre-calibration comprises:
calculating a plurality of dephasing decay parameters for a number of signal-to-noise (SNR) values; and
fitting a curve to the plurality of dephasing decay parameters, such that a dephasing decay parameter can be determined for additional SNR values.

11. The method of claim 1, wherein a second ion of the plurality of ions has an identical collisional cross section to the first ion, such that a collisional decay parameter of the second ion is equal to a collisional decay parameter of the first ion.

12. The method of claim 11, wherein a correction factor and/or an initial amplitude is calculated for the second ion using the collisional decay parameter of the first ion.

13. The method of claim 1, wherein a dephasing decay parameter or a correction factor is calculated without calculating a collisional decay parameter.

14. The method of claim 1, wherein two or more ions of the plurality of ions differ in their isotopic composition.

15. A Fourier Transform mass spectrometer, comprising:
a computer configured to:
receive an obtained mass spectrum of an ion sample, wherein the obtained mass spectrum includes a plurality of peaks indicating the abundance of each of a plurality of ions over an analysis time duration T in the ion sample, the plurality of ions decaying over time during the analysis time duration T;
calculate an initial amplitude of a transient signal of a first ion of the plurality of ions using a fit of an inverse Fourier Transform (FT) of a first peak of the plurality of peaks, wherein the first peak corresponds with the first ion; and
extrapolate the abundance of the first ion to a time at a start of the analysis time duration T.

16. The Fourier Transform mass spectrometer of claim 15, wherein the Fourier Transform mass spectrometer is an orbital trapping mass spectrometer.

17. The Fourier Transform mass spectrometer of claim 15, wherein the computer is configured to determine a collisional decay parameter and/or a dephasing decay parameter of the first peak.

18. The Fourier Transform mass spectrometer of claim 17, wherein the determining the collisional decay parameter and/or the dephasing decay parameter of the first peak comprises:
centering the first peak around zero frequency;
applying the inverse FT; and
fitting a function to the magnitude of the inverse FT.

19. The Fourier Transform mass spectrometer of claim 15, wherein the calculating the initial amplitude of the transient signal further comprises calculating a correction factor for the abundance, wherein the correction factor is calculated using a collisional decay parameter and a dephasing decay parameter.

20. A computer program product having stored thereon computer-executable instructions for performing a method for determining an initial abundance of one or more of a plurality of ions in an ion sample being analysed by a Fourier Transform Mass Spectrometer, the plurality of ions decaying over time during the analysis, the method comprising:
obtaining a mass spectrum of the ion sample, wherein the mass spectrum includes a plurality of peaks indicating the abundance of each of the plurality of ions over an analysis time duration T in the ion sample; and
calculating an initial amplitude of a transient signal of a first ion of the plurality of ions using a fit of an inverse Fourier Transform (FT) of a first peak of the plurality of peaks, wherein the first peak corresponds with the first ion, to extrapolate the abundance of the first ion to a time at a start of the analysis time duration T.
